(19) United States
(12) Patent Application Publication
(10) Pub. No.: US 2005/0062705 A1
(43) Pub. Date: Mar. 24, 2005

(54) Liquid crystal display device and method for driving the same

(75) Inventor: Yukimitsu Yamada, Miyagi-ken (JP)

Correspondence Address: BEYER WEAVER & THOMAS LLP, P.O. BOX 70250, OAKLAND, CA, 94612-0250, US

(73) Assignee: ALPS ELECTRIC CO., LTD.

(21) Appl. No.: 10/930,436

(22) Filed: Aug. 30, 2004

(30) Foreign Application Priority Data
Sep. 22, 2003 (JP) 2003-330733

(51) Int. Cl. G02F 1/1337

(52) U.S. Cl. 345/94

(57) ABSTRACT

An electric field is applied to a liquid crystal by supplying power to pixel electrodes via thin-film transistors. A voltage higher than a liquid crystal driving voltage, which is a maximum voltage that can be generated by a liquid-crystal driving power supply, is applied to the liquid crystal via all pixel electrodes connected to all thin-film transistors and a common electrode at the same time to thereby initialize the liquid crystal. After the initialization, a display operation is started.

### BACKGROUND OF THE INVENTION

1. Field of the Invention

The present invention relates to a liquid crystal display device and a method for driving the same. More particularly, the present invention relates to a liquid crystal display device and a method for driving the same using an OCB (optically compensated birefringence) mode, which realizes a wide-viewing-angle and high-speed-response display.

2. Description of the Related Art

One known liquid crystal display device that realizes a wide-viewing-angle and high-speed-response display is an OCB-mode liquid crystal display device that includes a bend-alignment liquid crystal cell, biaxial compensation films, and polarizers. The bend-alignment liquid crystal cell is arranged such that a liquid crystal is held between upper and lower substrates. The substrates each have an alignment layer that imparts a pre-tilt angle to the liquid crystal, with the upper and lower alignment layers being arranged to pre-tilts the liquid crystal in opposite directions. Thus, a bend-alignment structure is realized.

Generally, bend-alignment liquid crystal cells have two different alignment states, which are referred to as splay alignment and bend alignment of liquid crystal. When no voltage is applied between electrodes of the liquid crystal cell, the liquid crystal will assume the splay alignment state. However, to facilitate normal display operations, the liquid crystal must first be placed in the bend alignment state (see, for example, Japanese Unexamined Patent Application Publication No. 2001-290127). Therefore, a splay-to-bend alignment transition of liquid crystal is required to facilitate display operations. In the above-noted publication, in order to change the alignment state of liquid crystal to the bend alignment state, a driving circuit is provided in the liquid crystal cell for applying a bias electric field. The described technique contemplates applying an alignment transition signal to the liquid crystal cell before normal display driving operations of the OCB cell begins. More specifically, the described technique contemplates sequentially (1) applying an AC voltage on which a bias voltage is superimposed between the electrodes, and (2) applying a zero voltage or a low voltage between the electrodes a number of times. [I HAD DIFFICULTY UNDERSTANDING THIS PARAGRAPH—PLEASE CHECK TO SEE IF THIS IS CORRECT] Thus, the alignment transition to the bend alignment is carried out before a normal display operation in an OCB cell is started.

Another technique for splay-to-bend alignment transition of liquid crystal is disclosed in Japanese Unexamined Patent Application Publication No. 9-185037. In this technique, gate on/off periods of a thin film transistor (TFT) of a liquid crystal cell are controlled, a strong electric field is applied between a gate electrode and a common electrode, and, at the same time, a voltage higher than that required for maintaining the bend alignment is applied between a display electrode and the common electrode, to thereby realize short-time alignment transition to the bend alignment.

However, the techniques disclosed in the above-noted publications have problems.

In Japanese Unexamined Patent Application Publication No. 2001-290127, even when a bias voltage is applied from a liquid crystal driving circuit to a liquid crystal that is in a splay alignment state, the splay-to-bend transition can occur in various locations. The transition often occurs around dispersed spacers or at irregularities, scratches, or defects on the interfaces of alignment layer. It is therefore difficult for overall liquid crystal to experience uniform transition to bend alignment. The transition can occur in other locations, and therefore a uniform transition cannot be easily realized by the technique disclosed in this publication.

Moreover, the structure shown in this publication requires one or a plurality of driving circuits for phase transition, in addition to a typical liquid crystal driving circuit. Therefore, the driving circuit structure can become complex.

According to the technique disclosed in Japanese Unexamined Patent Application Publication No. 9-185037, a strong electric field is applied between a gate electrode of a TFT and a common electrode of a liquid crystal cell. However, how much voltage is applied to what type of liquid crystal cell and for how long to realize splay-to-bend alignment transition is not specifically described. Thus, it is unclear whether or not alignment transition to bend alignment is reliably effected.

### SUMMARY OF THE INVENTION

Accordingly, it is an object of the present invention to provide a liquid crystal display device and a method for driving the same in which transition from, for example, splay alignment to bend alignment of liquid crystal can reliably be effected using a traditional driving circuit, without an additional special circuit for phase transition from splay alignment to bend alignment of liquid crystal.

In one aspect, the present invention provides a method for driving a liquid crystal display device that includes a liquid crystal cell. In the liquid crystal cell, a plurality of gate lines and a plurality of source lines are formed into a matrix on a first substrate to form a plurality of pixel areas. Each pixel area has a thin-film transistor having a gate electrode and a source electrode, and a pixel electrode connected to the thin-film transistor. A second substrate having a common electrode faces the first substrate. A liquid crystal is held between the first and second substrates. The method includes applying an electric field to the liquid crystal by supplying power to the pixel electrodes via the thin-film transistors, initializing the liquid crystal by applying a voltage higher than a liquid-crystal driving voltage, which is a maximum voltage that can be generated by a liquid-crystal driving power supply, to the liquid crystal via all pixel electrodes connected to all of the thin-film transistors and the common electrode at the same time before starting a display operation, and starting driving the liquid crystal after initializing the liquid crystal.

Preferably, the liquid crystal is one of an OCB-mode liquid crystal having splay alignment and bend alignment, a TN-mode liquid crystal, and an STN-mode liquid crystal.

The liquid crystal may be initialized by applying a voltage higher than a maximum liquid-crystal driving voltage to the liquid crystal from the source electrodes of all of the plurality of thin-film transistors in a state where the gate electrodes of all of the plurality of thin-film transistors are turned on at the same time.

A maximum voltage that can be applied to the thin-film transistors from the power supply for driving the thin-film transistors may be selected as a voltage that is higher than the maximum liquid-crystal driving voltage.

When a polarity-inversion voltage with respect to a reference voltage is applied to the liquid crystal via the thin-film transistors to drive the liquid crystal, a voltage corresponding to a sum of absolute polarity-inversion driving voltages with respect to a reference potential of zero may be applied to initialize a liquid crystal material.

In another aspect, the present invention provides a liquid crystal display device including a liquid crystal cell. In the liquid crystal cell, a plurality of gate lines and a plurality of source lines are formed into a matrix on a first substrate to form a plurality of pixel areas. Each pixel area has a thin-film transistor having a gate electrode and a source electrode, and a pixel electrode connected to the thin-film transistor. A second substrate having a common electrode faces the first substrate. A liquid crystal is held between the first and second substrates. The liquid crystal display device further includes a gate driver connected to the gate lines and a source driver connected to the source lines, the gate driver having a function of turning on the gate electrodes of all of the plurality of thin-film transistors at the same time, and a power supply that applies a voltage higher than a liquid-crystal driving voltage at the same time to a liquid crystal material in all of the pixel areas via the turned on thin-film transistors.

Preferably, the liquid crystal is one of an OCB-mode liquid crystal having splay alignment and bend alignment, a TN-mode liquid crystal, and an STN-mode liquid crystal.

The voltage higher than the liquid-crystal driving voltage may be a maximum driving voltage of the power supply for driving the thin-film transistors.

In a structure in which a polarity-inversion voltage with respect to a reference voltage is applied to the liquid crystal via the thin-film transistors to drive the liquid crystal, a voltage corresponding to a sum of absolute polarity-inversion driving voltages with respect to a reference potential of zero may be applied to initialize the liquid crystal.

According to the present invention, therefore, the alignment state of liquid crystal is reset by applying a maximum voltage that can be generated by a liquid-crystal driving power supply to a liquid crystal of an OCB-mode liquid crystal cell before a display operation is started. Thus, splay-to-bend alignment transition of the OCB-mode liquid crystal can be realized without an additional special power supply or driving circuit. After transition to the bend alignment, the OCB-mode liquid crystal can be driven at a normal liquid-crystal driving voltage lower than the maximum voltage. Furthermore, a maximum voltage that can be generated by the liquid-crystal driving power supply is applied, to thereby reliably effect splay-to-bend alignment transition. The liquid crystal is not limited to an OCB-mode liquid crystal. Any liquid crystal, such as a TN-mode liquid crystal or an STN-mode liquid crystal, may be used. The alignment state of such a liquid crystal can be initialized and reset to smoothly realize a subsequent driving operation.

In the present invention, the liquid crystal is initialized by applying a voltage higher than a maximum liquid-crystal driving voltage to a liquid crystal from sources of all thin-film transistors in a state where gates of all thin-film transistors are turned on at the same time. Thus, the alignment of the overall liquid crystal can be effectively reset using a traditional liquid crystal driving circuit without an additional special circuit. In case of an OCB-mode liquid crystal that allows alignment transition from splay alignment to bend alignment, a traditional liquid crystal driving circuit can be used to effectively carry out splay-to-bend alignment transition of the overall liquid crystal without an additional special circuit.

In the present invention, when a polarity-inversion voltage with respect to a reference voltage is applied to a liquid crystal via thin-film transistors to drive the liquid crystal, a voltage corresponding to a sum of absolute polarity-inversion driving voltages with respect to a reference potential of zero is applied to initialize a liquid crystal material. Thus, splay-to-bend alignment transition of liquid crystal can be effected using a maximum voltage that can be generated by a liquid-crystal driving power supply. Therefore, alignment transition of liquid crystal can reliably be carried out.

### BRIEF DESCRIPTION OF THE DRAWINGS

FIG. 1 is a perspective view of an OCB-mode liquid crystal cell according to a first embodiment of the present invention;

FIG. 2 is an illustration of an alignment state of liquid crystal molecules of the OCB-mode liquid crystal cell of FIG. 1 under the application of an electric field;

FIG. 3 is an illustration of an alignment state of liquid crystal molecules of the OCB-mode liquid crystal cell of FIG. 1 when no electric field is applied;

FIG. 4 is an equivalent circuit diagram of a liquid crystal display device having the liquid crystal cell shown in FIG. 1;

FIG. 5 is a timing chart for driving the equivalent circuit shown in FIG. 4;

FIG. 6 is an equivalent circuit diagram of a liquid crystal display device having a liquid crystal cell according to a second embodiment of the present invention;

FIG. 7 is a timing chart for driving the equivalent circuit shown in FIG. 6; and

FIG. 8 is a graph showing the transmittance of a liquid crystal display device formed in accordance with the present invention.

### DESCRIPTION OF THE PREFERRED EMBODIMENTS

A liquid crystal display device according to a first embodiment of the present invention and a method for driving the liquid crystal display device will now be described with reference to the drawings.

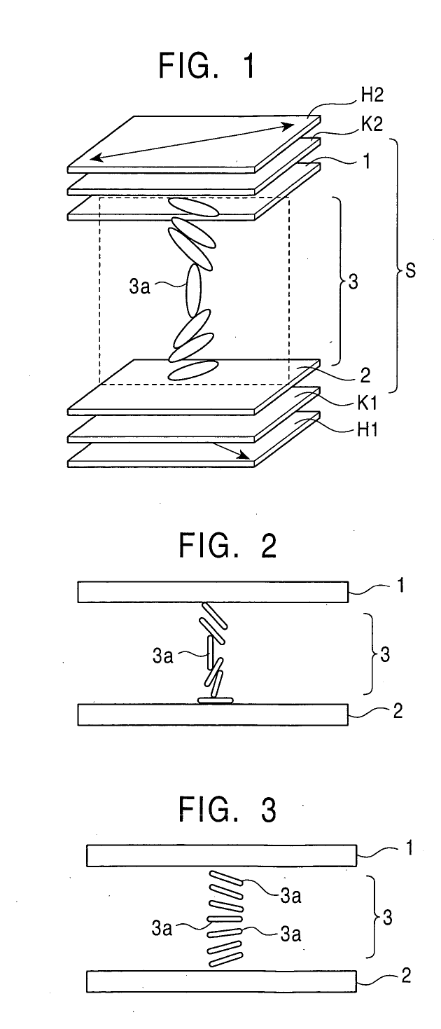

As shown in FIG. 1, the liquid crystal display device according to the first embodiment of the present invention includes a pair of upper and lower substrates 1 and 2 facing each other. A liquid crystal 3 is held between the substrates 1 and 2 via a sealant (not shown) applied around the substrates 1 and 2. An optical compensator K1 and a polarizer H1 are provided beneath the lower substrate 2, and an optical compensator K2 and a polarizer H2 are provided above the upper substrate 1. The polarizer H1 may be removed in the liquid crystal display device.

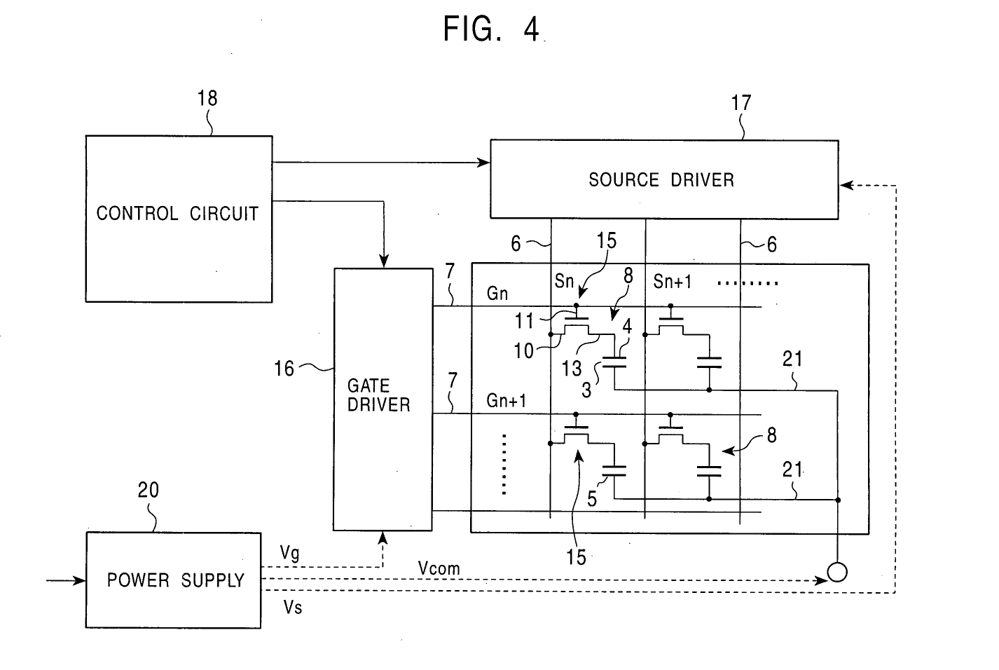

One of the substrates 1 and 2, (e.g., the upper substrate 1), has a common electrode that covers its entire surface and an alignment layer on the liquid-crystal side thereof. The other substrate, (i.e., the lower substrate 2 in this example), has a matrix driving circuit on the liquid-crystal side thereof. In its equivalent circuit diagram shown in FIG. 4, the matrix driving circuit includes a plurality of thin-film transistors (hereinafter referred to as TFTs) 15 and a plurality of source lines 6 and gate lines 7, which are arranged into a matrix. Thus, a liquid crystal cell S is constructed.

More specifically, the plurality of source lines 6 and the plurality of gate lines 7 are arranged into a matrix on the liquid crystal side of the substrate 2 so as to intersect each other with an insulator layer (not shown) therebetween. An intersecting area of each source line 6 and each gate line 7 serves as a pixel area 8, and each pixel area 8 includes the TFT 15. Each TFT 15 has a drain electrode 10 connected to the source line 6, a gate electrode 11 connected to the gate line 7, and a source electrode 13 connected to a pixel electrode 4 for liquid crystal driving. In an equivalent circuit diagram, a liquid crystal may be represented by a capacitor. Thus, in FIG. 4, the liquid crystal 3 connected to the source electrode 13 of the TFT 15 is indicated by a capacitor. The liquid crystal cell S corresponding to each pixel area 8 in the equivalent circuit diagram shown in FIG. 4 is schematically shown in cross section in FIG. 1. The foregoing circuit structure and panel structure are not different from the structure of a TFT liquid crystal panel having a typical thin-film transistor circuit.

The polarization axes of the polarizers H1 and H2 are 90° orthogonal, and the alignment layers of the substrates 1 and 2 impart opposite pre-tilt angle directions to the liquid crystal. When no voltage is applied to the liquid crystal cell S shown in FIG. 1, liquid crystal molecules 3a are placed in the splay alignment state, as shown in FIG. 3. Under the application of a voltage by an operation described below, the liquid crystal molecules 3a are placed in the bend alignment state shown in FIGS. 1 and 2.

The OCB-mode liquid crystal 3 may be any typical liquid crystal material, as for example, liquid crystal materials LC1 through LC6 shown in Japanese Patent No. 3183646.

Referring to FIG. 4, the plurality of gate lines 7 are individually connected to a gate driver 16, and the plurality of source lines 6 are individually connected to a source driver 17. The gate driver 16 and the source driver 17 are connected with a control circuit 18. The gate driver 16 and the source driver 17 are further connected with a power supply 20 for supplying a required electrical signal to the gate driver 16 and the source driver 17. The power supply 20 is also connected to feed lines 21 that are arranged substantially in parallel to the gate lines 7 on the substrate in an isolated manner from the gate lines 7 and the source lines 6. The feed lines 21 are connected to a common electrode 5, i.e., the common electrode on the upper substrate 1.

In this circuit structure, the power supply 20 supplies an electrical signal required for liquid crystal driving to the gate driver 16 and the source driver 17. The power supply 20 also supplies power to the common electrode 5. In the equivalent circuit diagram shown in FIG. 4, the liquid crystal 3 is sandwiched between the pixel electrode 4 formed in each pixel area 8, and the common electrode 5. While the common electrode 5 is shown in each pixel area 8 in the equivalent circuit diagram shown in FIG. 4, the common electrode 5 is an electrode that covers the entire display surface on the liquid crystal side of the substrate 1 in this example.

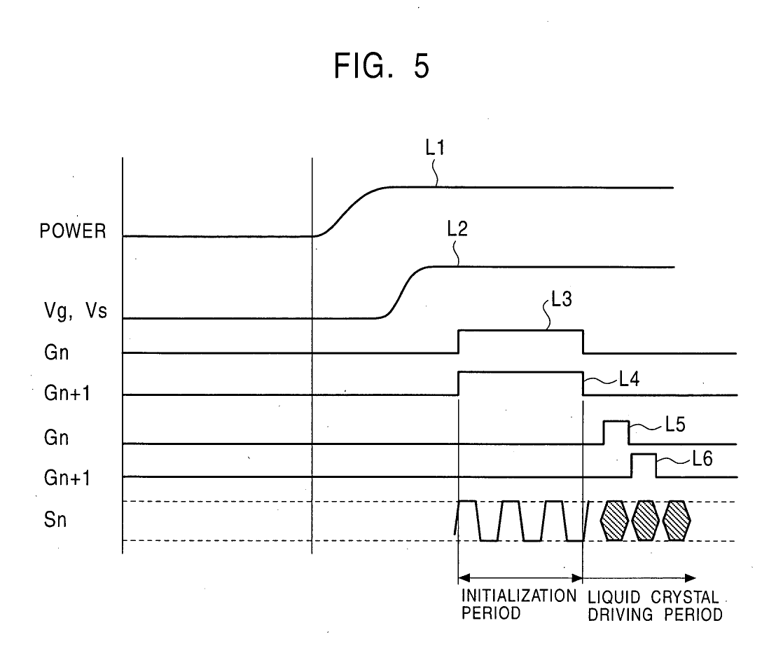

FIG. 5 is a timing chart for driving the circuit shown in FIG. 4.

First, the power supply 20 is turned on, as indicated by L1. This provides the electrical signal required to drive the gate driver 16 and the source driver 17. Driving pulses L3 and L4 are then applied at the same time to all gate lines Gn and Gn+1 for a period in the range of about 1 millisecond to 100 milliseconds to open the gates of all TFTs 15 to feed power from the power supply 20 to the source driver 17 and the plurality of feed lines 21. Thus, a required voltage can be applied directly from the power supply 20 between the pixel electrodes 4 and the common electrode 5 with the liquid crystal 3 therebetween. In a normal liquid-crystal driving operation, the plurality of gate lines 7 are sequentially scanned. In this embodiment, however, in order to initialize the liquid crystal, the gate lines 7 are not initially scanned. Rather, they are all fed with power from the power supply 20 at the same time for about 1 millisecond to 100 milliseconds, which has the effect of turning on the gates of all TFTs 15.

In this state, a voltage can be applied directly from the power supply 20 to all pixel electrodes 4 and the common electrode 5. The maximum voltage that can be generated by the power supply 20 is applied to the liquid crystal 3 via the pixel electrodes 4 and the common electrode 5, to thereby perform an initialization process. More specifically, for an initialization period shown in FIG. 5, the gates are turned on, and AC pulses in case of AC driving are continuously applied to perform initialization. This initialization process facilitates a splay-to-bend alignment transition of the liquid crystal.

It is presumed herein that a voltage of about +5 V is applied to the common electrode 5 in the initialization process. Generally, liquid crystal driving is implemented by AC driving, and a zero voltage or a voltage of about 10 V is applied to the pixel electrodes 4.

In the liquid crystal cell S, when no voltage is applied, the liquid crystal molecules 3a exhibit pre-tilts in opposite directions because the pre-tilt angles on the substrates 1 and 2 are in opposite directions. The alignment directions of the alignment layers on the substrate 1 and 2 are in parallel. In this state, therefore, the liquid crystal molecules 3a are placed in the splay alignment state shown in FIG. 3. In this case, the splay alignment state would not reliably be changed to the bend alignment state shown in FIGS. 1 and 2 merely by applying a liquid-crystal driving voltage. On the other hand, once the above-described initialization process is performed to forcibly change the alignment state to the bend alignment state, the OCB-mode liquid crystal can be driven by applying a driving voltage indicated by driving pulses L5 and L6, shown in FIG. 5, to the gate lines Gn and Gn+1.

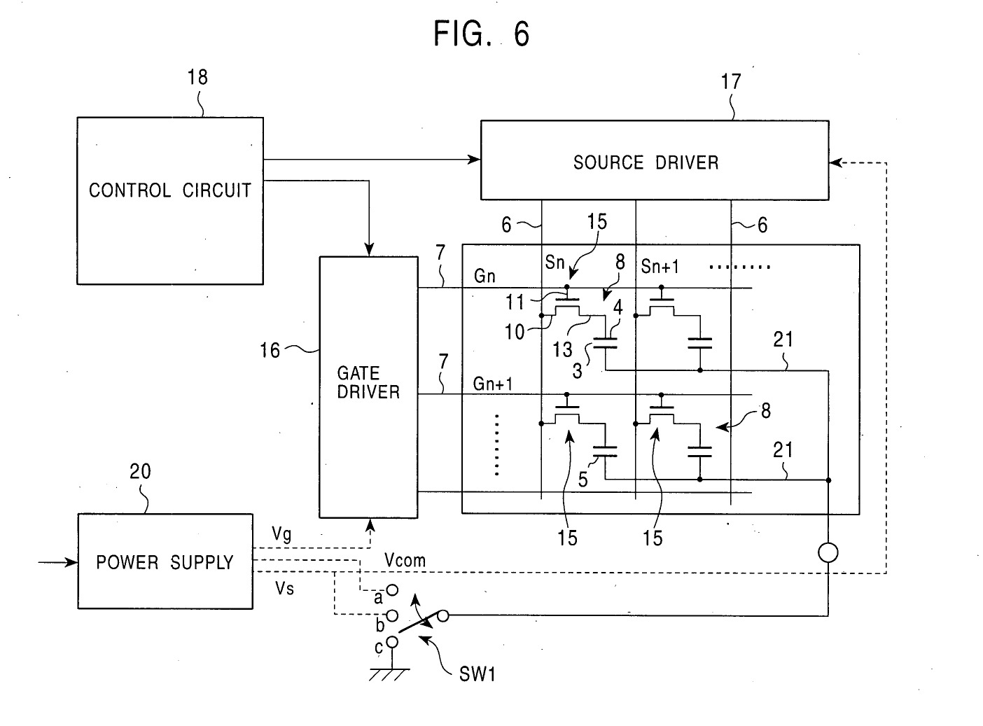

FIG. 6 is an equivalent circuit diagram of a liquid crystal display device according to a second embodiment of the present invention. In FIG. 6, the same elements as those shown in FIG. 4 are given the same reference numerals, and a description thereof is omitted.

The difference between the equivalent circuit diagram shown in FIG. 6 and the equivalent circuit diagram shown in FIG. 4 is a switch SW1 for selecting a terminal a, b, or c. When the terminal a is selected by the switch SW1, a potential equal to a half of the absolute maximum potential generated by the power supply 20 is selected. When the terminal b is selected by the switch SW1, a potential equal to the absolute maximum potential generated by the power supply 20 is selected. When the terminal c is selected by the switch SW1, a ground potential, i.e., 0 V, is selected.

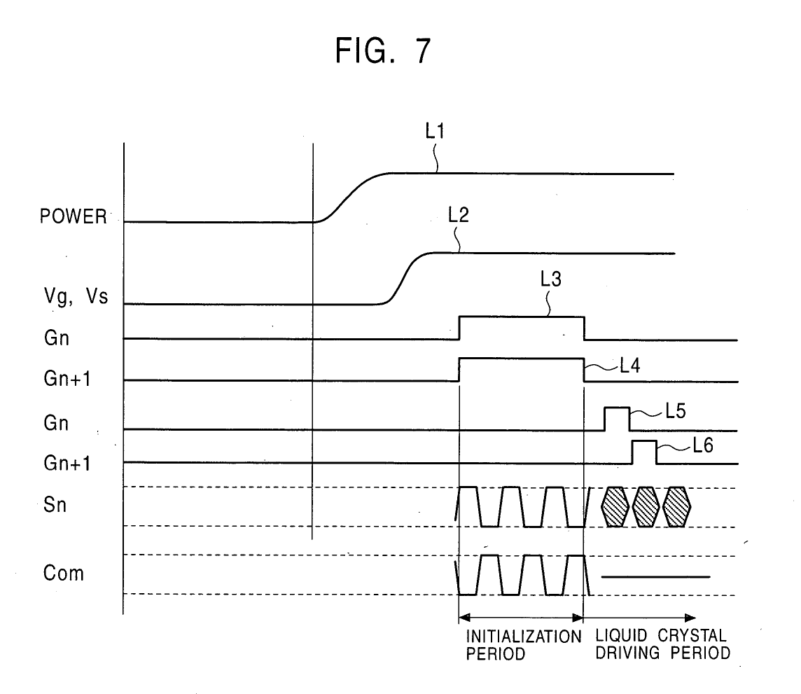

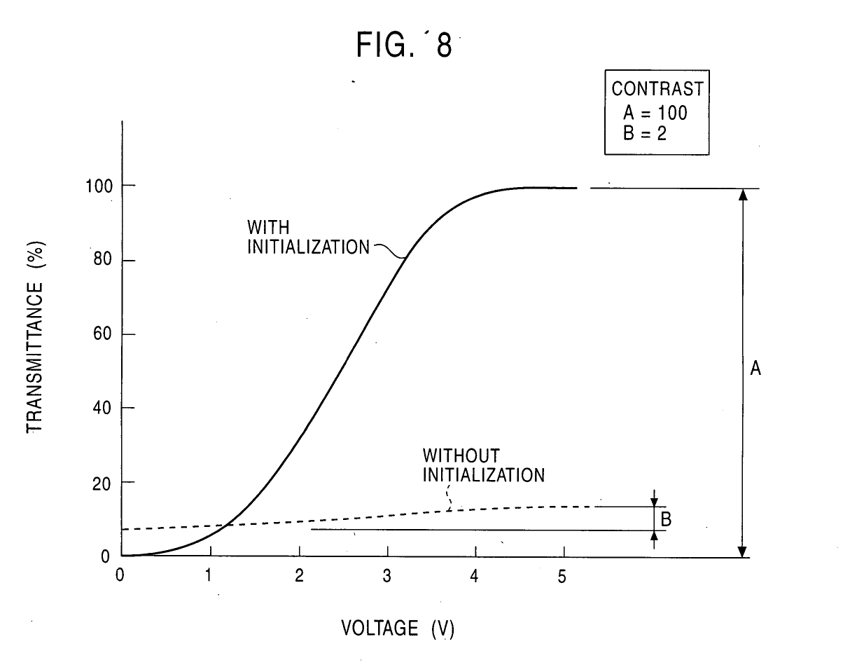

FIG. 7 is a timing chart for driving the circuit shown in FIG. 6.

First, the power supply 20 is turned on, as indicated by L1, and the switch SW1 selects the terminal c to select a ground potential, i.e., 0 V, so that a zero potential is fed to the common electrode 5 via the feed lines 21. An electrical signal required for driving is further supplied to the gate driver 16 and the source driver 17. Driving pulses L3 and L4 are applied at the same time to all gate lines Gn and Gn+1 for in the range of about 1 millisecond to 100 milliseconds to open the gates of all TFTs 15 to feed power from the power supply 20 to the source driver 17 and the plurality of feed lines 21. Thus, a maximum voltage can be applied directly from the power supply 20 between the pixel electrodes 4 and the common electrode 5 with the liquid crystal 3 therebetween.

In a normal liquid-crystal driving operation, the plurality of gate lines 7 are sequentially scanned for driving with a certain time delay. In this embodiment, however, to initialize the liquid-crystal, all of the gate lines 7 are not scanned but rather are fed with power from the power supply 20 at the same time for about 1 millisecond to 100 milliseconds to turn on the gates of all of the TFTs 15.

In this state, the absolute maximum voltage generated by the power supply 20 is applied to the liquid crystal 3 via the pixel electrodes 4 and the common electrode 5. More specifically, for an initialization period shown in FIG. 7, the gates are turned on, and AC pulses in case of AC driving are continuously applied to perform initialization. This initialization process causes a splay-to-bend alignment transition in the liquid crystal.

It is presumed herein that a potential of about +5 V is applied to the common electrode 5 and a potential of 0 V to 10 V is applied to the pixel electrodes 4 for driving in a normal liquid crystal driving operation. In case of the initialization process described above, the switch SW1 is connected to the terminal c to feed a zero potential to the common electrode 5, while a potential of +10 V is applied to the pixel electrodes 4. Thus, the initialization is attained.

In an initialization process using AC driving, the switch SW1 is operated so as to select a potential with opposite phase to the potential to be applied to the pixel electrodes 4, to thereby constantly apply the maximum potential that can be generated by the power supply 20 to the liquid crystal 3 in the initialization process using AC driving. For example, a potential of +10 V and a zero potential are alternately applied to the pixel electrodes 4, and a zero potential and a potential of +10 V are alternately applied to the common electrode 5 to perform the initialization process using AC driving.

In a normal liquid-crystal driving operation, the switch SW1 is connected to the terminal a to apply a potential of +5 V to the common electrode 5, while a potential ranging 0 to 10 V is applied to the pixel electrodes 4. Thus, the liquid-crystal AC driving shown in FIG. 7 is attained.

In the liquid crystal cell S, when no voltage is applied, the liquid crystal molecules 3a exhibit pre-tilts in opposite directions because the pre-tilt angles on the substrates 1 and 2 are in opposite directions. The liquid crystal molecules 3a are therefore placed in the splay alignment state shown in FIG. 3. In this case, the splay alignment state is not changed to the bend alignment state shown in FIGS. 1 and 2 merely by applying a liquid-crystal driving voltage. On the other hand, once the above-described initialization process is performed to change the alignment state to the bend alignment state, the OCB-mode liquid crystal can be driven by applying a driving voltage indicated by driving pulses L5 and L6, shown in FIG. 7, to the gate lines Gn and Gn+1.

The present invention has been described in the context of an OCB-mode liquid crystal display device and a method for driving the same. The present invention is also applicable to a TN-mode liquid crystal display device or an STN-mode liquid crystal display device. Also in a TN-mode or STN-mode liquid crystal, in order to avoid non-smooth alignment transition of the liquid crystal, the alignment state of the liquid crystal is forcibly changed depending upon the application of a voltage or the application of no voltage, to thereby realize smooth alignment transition.

In a specific example, two transparent glass substrates face each other with a cell gap of 7 μm or less therebetween. An OCB-mode liquid crystal is injected between the substrates, and the substrates are bonded by a sealant to construct a liquid crystal cell. The OCB-mode liquid crystal employs a nematic liquid crystal.

On the lower glass substrate, 640 molybdenum-tantalum-alloy gate lines having a width of 3 μm and 480 aluminum source lines having a width of 3 μm are arranged into a matrix with an SiNx interlayer insulator film therebetween, and pixel areas of 90 μm×90 μm are defined. Of course, the number of gate and source lines as well as their size and composition may be widely varied. Each pixel area includes a TFT, and the TFT has a source electrode connected to a pixel electrode made of aluminum. In this way, an active-matrix substrate is realized. A planarizing layer and an alignment layer made of polyimide are formed on this substrate, and the alignment layer is rubbed in a parallel direction to the right-and-left direction of the substrate so as to give a pre-tilt angle of 150 or less. Each TFT is a typical inverted-staggered TFT having a phosphorus-doped amorphous silicon layer and an n-channel amorphous silicon layer sandwiched between gate and source electrodes made of aluminum. The source electrode of each TFT is connected with a pixel electrode formed of an ITO transparent electrode.

On the liquid crystal side of the upper glass substrate, an ITO common electrode that covers the entire surface of this substrate and an alignment layer made of polyimide are formed. The alignment layer is rubbed in a parallel direction to the above-mentioned substrate so as to give a pre-tilt angle of 7° or less, and is directed in an opposite (180°) orientations to the above-mentioned substrate.

In this liquid crystal cell, the gates of all TFTs, wherein the source voltage was set to 10 V and the gate voltage was set to 20 V, were turned on for a period of 10 milliseconds to apply a zero voltage and a voltage of 10 V to the pixel electrodes and a voltage of +5 V to the entirety of the common electrode from a power supply for a period of 10 milliseconds, to thereby initialize the liquid crystal.

Then, a voltage of 5 V was applied to the pixel electrodes, and a voltage ranging from zero to 5 V was applied to the entirety of the common electrode from the power supply so that the source voltage of the TFTs was set to 0 V and 10 V and the gate voltage was set to 15 V, to thereby drive the liquid crystal. As a result, a standard liquid-crystal display state with color reproducibility and without variations in color was realized on the entirety of the substrate.

FIG. 8 shows an experimental result of the transmittance of a liquid crystal cell with respect to applied voltage in a white display state and a black display state of a normally-black OCB-mode liquid crystal display device according to the present invention. In this case, polarizers whose polarization axes are 180° different from each other are provided above and beneath the liquid crystal cell. A backlight on the opposite side of the lower substrate is lit, and the light is detected by a CCD photodetector disposed 50 cm above the upper substrate. Thus, a change in the transmittance of the liquid crystal display device is measured. In this experiment, the measurement was performed separately in the white display state and the black display state five times each, and a mean for the measured values was determined.

The experimental result shows that a desirable display having a contrast of 100 or higher without variations in color or without a missing pixel was realized.

FIG. 8 also shows an experimental result of a comparative example under equivalent conditions, except that liquid crystal is driven without initialization. In this comparative example, the application of a voltage was less effective, and a contrast of 10 or less was exhibited in either the white display state or the black display state. Moreover, due to unstable alignment, the birefringence effect of light caused variations in color.

Using the liquid crystal cell in this specific example, desirable display of a variety of images without variations in color was achieved. It is therefore proved that a voltage higher than a normal liquid-crystal driving voltage is applied to a liquid crystal to initialize the liquid crystal before a display operation is started, thus achieving desirable driving and display performance in an OCB-mode liquid crystal.

Although only a few embodiments of the invention have been described in detail, it should be appreciated that the invention may be implemented in many other specific forms without departing from the spirit or scope of the invention. For example, the invention may be used to initialize displays of virtually any size and the composition of the components (e.g., the electrodes, the liquid crystal material, the substrates, the alignment layers etc.) may be widely varied. Similarly either the upper or the lower substrate may host the common electrode and the other may host the pixel electrodes. Therefore, the present embodiments are to be considered as illustrative and not restrictive and the invention is not to be limited to the details given herein, but may be modified within the scope of the appended claims.

1. A method for driving a liquid crystal display device including a liquid crystal cell, the liquid crystal cell including a first substrate, a plurality of gate lines and a plurality of source lines formed into a matrix on the first substrate to form a plurality of pixel areas, each pixel area having a thin-film transistor having a gate electrode and a source electrode and a pixel electrode connected to the thin-film transistor, a second substrate that faces the first substrate and that has a common electrode, and a liquid crystal held between the first and second substrates,
the method comprising:
applying an electric field to the liquid crystal by supplying power to the pixel electrodes via the thin-film transistors;
initializing the liquid crystal by applying a voltage higher than a liquid-crystal driving voltage, which is a maximum voltage that can be generated by a liquid-crystal driving power supply, to the liquid crystal via all pixel electrodes connected to all of the thin-film transistors and the common electrode at the same time before starting a display operation; and
starting driving the liquid crystal after initializing the liquid crystal.

2. The method according to claim 1, wherein the liquid crystal comprises one of an OCB-mode liquid crystal having splay alignment and bend alignment, a TN-mode liquid crystal, and an STN-mode liquid crystal.

3. The method according to claim 1, wherein the liquid crystal is initialized by applying a voltage higher than a maximum liquid-crystal driving voltage to the liquid crystal from the source electrodes of all of the plurality of thin-film transistors in a state where the gate electrodes of all of the plurality of thin-film transistors are turned on at the same time.

4. The method according to claim 1, wherein a maximum voltage that can be applied to the thin-film transistors from the power supply for driving the thin-film transistors is selected as the voltage higher than the maximum liquid-crystal driving voltage.

5. The method according to claim 1, wherein when a polarity-inversion voltage with respect to a reference voltage is applied to the liquid crystal via the thin-film transistors to drive the liquid crystal, a voltage corresponding to a sum of absolute polarity-inversion driving voltages with respect to a reference potential of zero is applied to initialize a liquid crystal material.

6. A liquid crystal display device comprising:
a liquid crystal cell including:
a first substrate;
a plurality of gate lines and a plurality of source lines formed into a matrix on the first substrate to form a plurality of pixel areas, each pixel area having a thin-film transistor having a gate electrode and a source electrode and a pixel electrode connected to the thin-film transistor;
a second substrate that faces the first substrate and that has a common electrode; and
a liquid crystal held between the first and second substrates;
a gate driver connected to the gate lines and a source driver connected to the source lines, the gate driver having a function of turning on the gate electrodes of all of the plurality of thin-film transistors at the same time; and
a power supply that applies a voltage higher than a liquid-crystal driving voltage at the same time to all of the pixel areas via the turned on thin-film transistors.

7. The liquid crystal display device according to claim 6, wherein the liquid crystal comprises one of an OCB-mode liquid crystal having splay alignment and bend alignment, a TN-mode liquid crystal, and an STN-mode liquid crystal.

8. The liquid crystal display device according to claim 6, wherein the voltage higher than the liquid-crystal driving voltage comprises a maximum driving voltage of the power supply for driving the thin-film transistors.

9. The liquid crystal display device according to claim 6, wherein, in a structure in which a polarity-inversion voltage with respect to a reference voltage is applied to the liquid crystal via the thin-film transistors to drive the liquid crystal, a voltage corresponding to a sum of absolute polarity-inversion driving voltages with respect to a reference potential of zero is applied to initialize the liquid crystal.
